(19) United States
(12) Patent Application Publication
(10) Pub. No.: US 2026/0164084 A1
(43) Pub. Date: Jun. 11, 2026

(54) ELECTRONIC DEVICE AND METHOD OF OPERATING THE ELECTRONIC DEVICE

(71) Applicant: Samsung Electronics Co., Ltd., Suwon-si (KR)

(72) Inventors: Sangkwon NA, Suwon-si (KR); Jeongsik CHEON, Suwon-si (KR)

(21) Appl. No.: 19/434,926

(22) Filed: Dec. 29, 2025

Related U.S. Application Data
(63) Continuation of application No. PCT/KR2025/017817, filed on Nov. 3, 2025.

(30) Foreign Application Priority Data
Dec. 6, 2024 (KR) 10-2024-0180729

(51) Int. Cl. H04N 21/437; H04N 21/2187; H04N 21/438; H04N 21/845; H04N 21/858

(52) U.S. Cl. CPC H04N 21/437; H04N 21/2187; H04N 21/4383; H04N 21/8456; H04N 21/8586

(57) ABSTRACT

Provided is an electronic device which, when a playback request for a channel providing live streaming content is received, obtains, from a server, a plurality of segments based on an index file corresponding to the channel, determines whether there is most-recent segment information stored in correspondence with the channel, the most-recent segment information including information about a segment that was most recently played back in a previous playback on the channel, based on there being the most-recent segment information, identifies a playback start segment using the most-recent segment information and information about a segment designated based on the index file, and plays back the identified playback start segment.

### CROSS-REFERENCE TO RELATED APPLICATIONS

This application is a continuation of International Application No. PCT/KR2025/017817 designating the United States, filed on Nov. 3, 2025, in the Korean Intellectual Property Receiving Office and claiming priority to Korean Patent Application No. 10-2024-0180729, filed on Dec. 6, 2024, the disclosures of each of which are incorporated by reference herein in their entireties.

### BACKGROUND

### Field

The disclosure relates to an electronic device and a method of operating the electronic device, and for example, to an electronic device capable of smoothly controlling playback of live streaming content, and a method of operating the electronic device.

### Description of Related Art

As free advertising streaming television (FAST) has become widespread, various items of streaming content has been organized into TV channels, and thus, 24-hour viewing is available. Each channel may be mapped to a separate a uniform resource locator (URL), based on a streaming protocol such as HyperText Transfer Protocol (HTTP) live streaming (HLS). When a certain channel is selected in response to a user request, streaming content may be downloaded using a URL mapped to the selected channel and may be played back on a TV. As each URL is mapped to an independent channel, content may be switched and viewed by switching channels as selected on a TV, rather than browsing content via a user interface provided by a content provider such as YouTube® or Netflix® and selecting the content to watch.

### SUMMARY

According to an example embodiment of the disclosure, an electronic device may include: a memory including one or more instructions, and at least one processor, comprising processing circuitry, individually and/or collectively, configured to execute the one or more instructions and to cause the electronic device to: based on a playback request for a channel providing live streaming content being received, obtain, from a server, a plurality of segments based on an index file corresponding to the channel; determine whether there is most-recent segment information stored in correspondence with the channel, the most-recent segment information including information about a segment that was most recently played back in a previous playback on the channel; based on the most-recent segment information existing, identify a playback start segment using the most-recent segment information and information about a segment designated based on the index file; and play back the identified playback start segment.

According to an example embodiment of the disclosure, a method of operating an electronic device may include: based on a playback request for a channel providing live streaming content being received, obtaining, from a server, a plurality of segments based on an index file corresponding to the channel; determining whether there is most-recent segment information stored in correspondence with the channel, the most-recent segment information including information about a segment that was most recently played back in a previous playback on the channel; based on the most-recent segment information existing, identifying a playback start segment using the most-recent segment information and information about a segment designated based on the index file; and playing back the identified playback start segment.

According to an example embodiment of the disclosure, provided is a non-transitory computer-readable medium storing one or more instructions executable by at least one processor, comprising processing circuitry, of an electronic device, wherein the one or more instructions, when executed by at least one processor, individually and/or collectively, may cause the electronic device to: based on a playback request for a channel providing live streaming content being received, obtain, from a server, a plurality of segments based on an index file corresponding to the channel, determine whether there is most-recent segment information stored in correspondence with the channel, the most-recent segment information including information about a segment that was most recently played back in a previous playback on the channel, based on the most-recent segment information existing, identify a playback start segment using the most-recent segment information and information about a segment designated based on the index file, and play back the identified playback start segment.

### BRIEF DESCRIPTION OF THE DRAWINGS

The disclosure will now be described more fully through the detailed descriptions below with reference to the accompanying drawings, in which reference numerals denote structural elements. Further, the above and other aspects, features and advantages of certain embodiments of the present disclosure will be more apparent from the following detailed description, taken in conjunction with the accompanying drawings, in which:

FIG. 1 is a reference diagram illustrating an example HyperText Transfer Protocol (HTTP) live streaming system according to an example;

FIG. 2 is a block diagram illustrating an example configuration of a system according to various embodiments;

FIG. 3 is a block diagram illustrating an example configuration of an electronic device according to various embodiments;

FIG. 4 is a block diagram illustrating an example configuration of an electronic device according to a function of an electronic device according to various embodiments;

FIG. 5 is a flowchart illustrating an example method of operating an electronic device, according to various embodiments;

FIG. 6 is a signal flow diagram illustrating an example method of operating an electronic device, according to various embodiments;

FIG. 7 is a diagram illustrating an example of a master index file and an index file, according to various embodiments;

FIG. 8 is a diagram illustrating an example of an index file according to various embodiments;

FIG. 9 is a diagram illustrating an example of an index file that is received periodically, according to various embodiments;

FIG. 10 is a flowchart illustrating an example method of operating an electronic device, according to various embodiments;

FIG. 11 is a diagram illustrating an example of a most-recent segment number and an index file, according to various embodiments; and

FIG. 12 is a diagram illustrating an example scenario in which a segment is naturally processed according to channel switching and returning, according to various embodiments.

### DETAILED DESCRIPTION

The terms used in the disclosure will be briefly defined, and various example embodiments of the disclosure will be described in greater detail.

Although the terms used in the disclosure are selected from among common terms that are currently widely used in consideration of their functions in the disclosure, the terms may vary according the intention of one of ordinary skill in the art, a precedent, or the advent of new technology. Some terms may be arbitrarily selected, and in this case, the meaning of the selected terms will be described in detail in the detailed description of the disclosure. Therefore, the terms used in the disclosure should not be interpreted based on only their names but have to be defined based on the meaning of the terms together with the descriptions throughout the disclosure.

When a part “includes” or “comprises” an element, unless there is a particular description contrary thereto, the part may further include other elements, not excluding the other elements. Terms such as “... unit,” “module,” or the like used in the disclosure indicate a unit, which processes at least one function or operation, and the unit may be implemented by hardware or software, or by a combination of hardware and software.

Hereinafter, various example embodiments of the disclosure will be described in greater detail with reference to the accompanying drawings. The disclosure may, however, be embodied in many different forms and should not be construed as being limited to an embodiment of the disclosure set forth herein. In addition, in the drawings, parts irrelevant to the description may be omitted for clarity, and like elements are denoted by like reference numerals throughout the disclosure.

In the disclosure, the term “user” refers to a person who controls the functions or operations of a computing device or an electronic device using a control device, and may include a viewer, an administrator, or an installer. In the disclosure, a user of an electronic device which provides broadcasting may be referred to as a gamer, a player, a streamer, or the like, and a user of a device which views the broadcasting may be referred to as a viewer.

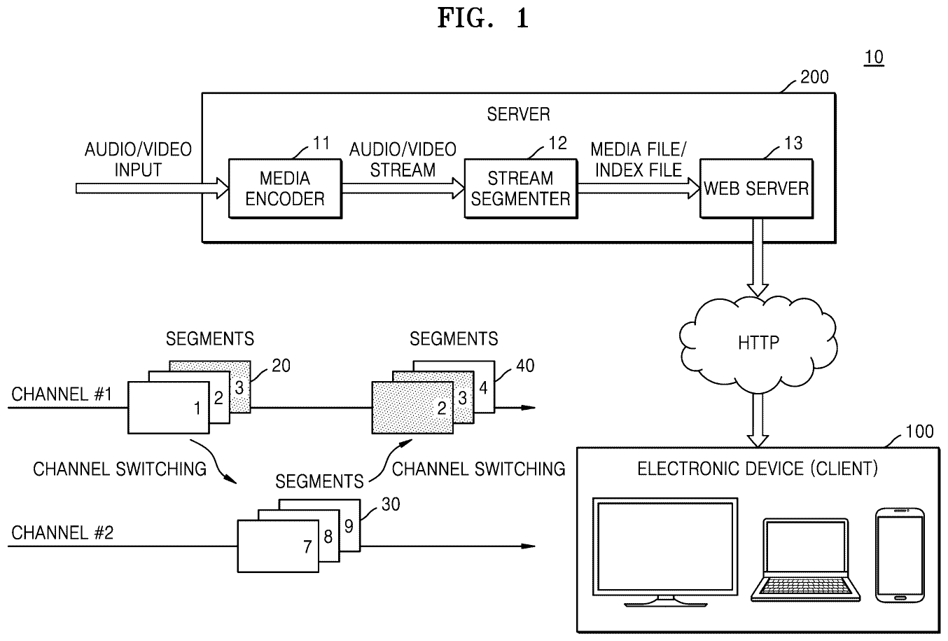

FIG. 1 is a reference diagram illustrating an example HyperText Transfer Protocol (HTTP) live streaming system according to an example.

Video live streaming refers to a method of transmitting captured information in real time to a user's video player for playback, the method being similar to live television broadcasting. In on-demand streaming, a video file is produced through filming and editing and then is ready for playback in response to a request by a user, however, in live streaming, a video and audio may be encoded in real time and simultaneously transmitted to many users.

Referring to FIG. 1, a live streaming system 10 may include a client 100 and a server 200.

The server 200 may include a media encoder 11, a stream segmenter 12, and a web server 13.

The media encoder 11 may receive an audio and video input, and may encode the received audio and video input. For example, the media encoder 11 may encode the audio and video input into a high efficiency video coding (HEVC) video and audio codec-3 (AC-3) audio. The media encoder 11 may output a stream segment by generating the encoded audio and video into a Moving Picture Experts Group (MPEG)-4 file or MPEG-2 transmission stream.

The stream segmenter 12 segments the received stream to generate a series of short media files each being referred to as a segment. Also, the stream segmenter 12 generates an index file as metadata that is accessible to the media files and includes a list of media files. The stream segmenter 12 transmits the generated media file and the index file to the web server 13. The index file may have an m3u8 format. The index file may be referred to as a playlist or a manifest.

The web server 13 maintains the media file and the index file received from the stream segmenter 12, and publishes a universal resource locator (URL) of the index file. In response to a request from the electronic device 100 that is the client, the web server 13 transmits the index file and the media file to the client.

The electronic device 100 may read the index file published by the web server 13, may request and read the media files included in the index file, and thus, may play back the media files.

Existing protocols for live streaming may include Real-Time Streaming Protocol (RTSP)/Real-Time Transport Protocol (RTP), Real-Time Messaging Protocol (RTMP), or the like. A streaming server using the protocols is required to have functions not only for transmitting video data but also for analyzing information about a video and reading and transforming video files to comply with transmission standards. Due to its various functions, the streaming server generally has higher implementation costs, compared to a web server. On the other hand, in HTTP live streaming that uses HTTP as a transmission channel, because HTTP is not a full-duplex scheme, only requests from a firewall to a HTTP server need to be allowed, and thus, configuration of the firewall is simplified. As a request and a response correspond one-to-one, communication with a server is easy even in a network address translation (NAT) environment.

In HTTP live streaming (HLS), the server functions only to receive a request via HTTP and provides a response to a player. The server reads a requested file without transformation and transmits it in a response as it is read. For example, any web server capable of reading a stored file and transmitting data in a HTTP response may be used.

In HTTP live streaming, when there is a request from the client for a particular channel, the server may periodically transmit, to the client, a defined number of segments of audio and video data provided in the requested channel. Accordingly, the client may play back a segment received from the server. However, when a channel switching time is short, a situation in which the client plays back an overlapping segment may occur. For example, referring to FIG. 1, while the client requests channel #1, receives and plays back segments 20 corresponding to channel #1, the client may receive a switch request from channel #1 to channel #2 from a user. The client may request channel #2, receive and play back segments 30 corresponding to channel #2. When the client plays back segments 30 corresponding to channel #2 and then receives a switch request to channel #1, the client may request again channel #1, receive and play back segments 40 corresponding to channel #1. In this case, as a time point at which the client plays back segments 40 is later than a time point at which segments 20 are played back, it is natural that a video displayed by playing back segments 40 corresponds to a point in time later than a video corresponding to segments 20. However, due to a structure of an HLS format that is played back in segment units, the video displayed by playing back segments 40 may be the same as or earlier than the most-recent video displayed on channel #1before switching from channel #1 to channel #2. For example, referring to FIG. 1, segments 20 of channel #1 may include segments 1, 2, and 3, and the client switches channels while displaying segment 3, and then segments 40 may include segments 2, 3, and 4 upon returning to channel #1. In this case, the client may display segment 2 or segment 3 included in segments 40. From a user's perspective, when a user returns to channel #1 after switching from channel #1 to channel #2 and watches the same video content that the user most recently watched on channel #1 before the switch to channel #2, the user may have a very awkward and unnatural viewing experience. Therefore, the disclosure provides, via an embodiment, an electronic device capable of preventing and/or reducing an unnatural and awkward viewing experience.

According to an embodiment of the disclosure, when a playback request for a channel providing live streaming content is received, the electronic device 100 may obtain, from a server, a plurality of segments based on an index file corresponding to the channel.

According to an embodiment of the disclosure, the electronic device may determine whether there is most-recent segment information stored in correspondence with the channel, the most-recent segment information including information about a segment that was most recently played back in a previous playback on the channel.

According to an embodiment of the disclosure, in a case where there is the most-recent segment information, the electronic device may identify a playback start segment using the most-recent segment information and information about a segment specified based on the index file.

According to an embodiment of the disclosure, the electronic device may play back the identified playback start segment.

According to an embodiment of the disclosure, in a case where there is the most-recent segment information, when a segment number of the segment specified based on the index file is equal to or less than a segment number of the most-recent segment, the electronic device may identify, as the playback start segment, a segment corresponding to a next segment number subsequent to the segment number of the most-recent segment.

According to an embodiment of the disclosure, when the segment number of the segment specified based on the index file is greater than the segment number of the most-recent segment, the electronic device may identify, as the playback start segment, the segment specified based on the index file.

According to an embodiment of the disclosure, in a case where the most-recent segment information does not exist, the electronic device may identify, as the playback start segment, the segment specified based on the index file.

According to an embodiment of the disclosure, the segment specified based on the index file may indicate a segment corresponding to a segment number that is located at a specified position from among segment numbers of the plurality of segments included in the index file.

According to an embodiment of the disclosure, when a playback end request for the channel is received, the electronic device may store a segment number of a segment most recently played back on the channel as the most-recent segment information corresponding to the channel.

According to an embodiment of the disclosure, the index file may include information about each of the plurality of segments, the information about each segment includes a URL for obtaining each segment, and the URL may include information indicating a segment number of each segment.

According to an embodiment of the disclosure, the electronic device may transmit a request to the server using a URL for each segment of the plurality of segments included in the index file, and may receive, from the server, the plurality of segments corresponding to the index file.

According to an embodiment of the disclosure, the electronic device may periodically request the server for the index file and receive an updated index file from the server.

According to an embodiment of the disclosure, the electronic device may receive, from the server, an updated plurality of segments based on the updated index file.

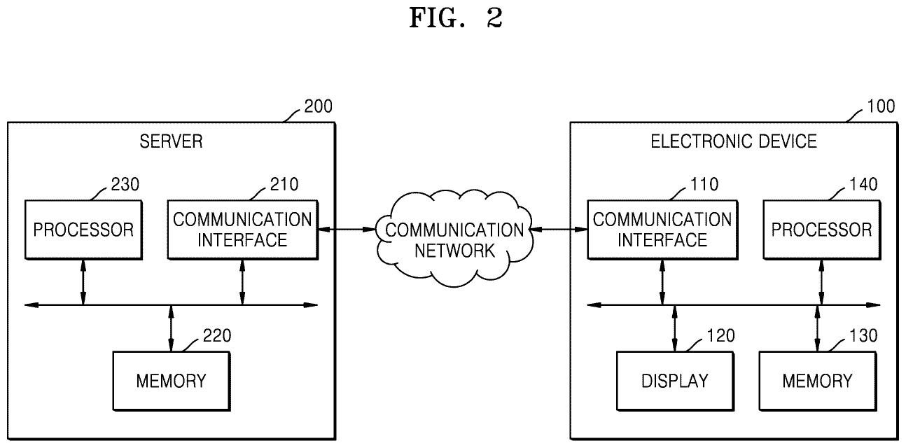

FIG. 2 is a diagram illustrating an example of a system according to various embodiments.

Referring to FIG. 2, the system may include the electronic device 100 and the server 200 connected via a communication network.

According to an embodiment of the disclosure, the electronic device 100 may receive and display video content from the server 200. The electronic device 100 may be implemented as various forms including, for example, and without limitation, a television (TV), a set-top box, a mobile phone, a tablet personal computer (PC), a digital camera, a camcorder, a notebook computer (laptop computer), a desktop PC, an electronic book reader, a terminal for digital broadcasting, a personal digital assistant (PDA), a portable multimedia player (PMP), a navigation device, an MP3 player, a wearable device, or the like. The electronic device 100 may be a stationary electronic device that is placed at a fixed location or a mobile electronic device having a portable form, and may be a digital broadcasting receiver capable of receiving digital broadcasting. The electronic device 100 may be controlled by a device in various forms including a remote controller, a mobile phone, a game pad, etc., using infrared (IR), Bluetooth (BT), Wi-Fi, etc.

The electronic device 100 may include a device capable of displaying an image or data, in response to a request by a user, and may include a communication interface (e.g., including communication circuitry) 110, a display 120, a memory 130, and a processor (e.g., including processing circuitry) 140.

The communication interface 110 may include various types of communication circuitry for performing communication with at least one external device. Here, the “communication” may refer to an operation of transmitting and/or receiving data, a signal, a request, and/or a command.

The communication interface 110 may perform wired or wireless communication with at least one external device. An external device may include the server 200.

For example, the communication interface 110 may include at least one of a communication module, communication circuitry, a communication device, an input/output port, or an input/output plug for performing wired or wireless communication with at least one external device.

For example, the communication interface 110 may include at least one wireless communication module, wireless communication circuitry, or a wireless communication device for performing wireless communication with at least one external device.

For example, the communication interface 110 may include a short-range communication module such as an IR communication module capable of receiving a control command from a remote control device (remote controller) such as an input device located within a short distance. In this case, the communication interface 110 may receive a control signal from the remote control device.

In an example, the communication interface 110 may include at least one communication module for performing communication according to a wireless communication standard including Bluetooth low energy (BLE), near-field communication (NFC)/radio frequency identification (RFID), Wi-Fi Direct (WFD), ultra-wideband (UWB), ZigBee, or the like. The communication interface 110 may further include a communication module for performing communication with a server for supporting long-range communication according to a long-range communication standard. For example, the communication interface 110 may include a communication module for performing communication via a network for Internet communication. Also, the communication interface 110 may include a communication module for performing communication via a communication network that follows a communication standard such as 3^{rd}-generation (3G), 4^{th}-generation (4G), 5^{th}-generation (5G) and/or 6^{th}-generation (6G).

In an example, the communication interface 110 may include at least one port for connection to an external device via a wired cable so as to communicate with the external device by wire. For example, the communication interface 110 may include at least one of a high-definition multimedia interface (HDMI) port, a component jack, a PC port, or a universal serial bus (USB) port. Accordingly, the communication interface 110 may perform communication with an external device connected by wire via at least one port. The port may refer to a physical hardware configuration into which a cable, a communication line, or a plug may be connected or inserted.

As described above, the communication interface 110 may include one or more support elements for supporting communication between the electronic device 100 and an external device. In this regard, the support elements may include the communication module, the communication circuitry, the communication device, the port (for input/output of data), the cable port (for input/output of data), the plug (for input/output of data), or the like. For example, at least one support element included in the communication interface 110 may include an Ethernet communication module, a Wi-Fi communication module, a Bluetooth communication module, an IR communication module, a USB port, a tuner (or, broadcasting receiver), an HDMI port, a display port (DP), a digital visual interface (DVI) port, or the like.

For example, the communication interface 110 may exchange data with a communication interface 210 of the server 200 according to HTTP. The HTTP refers to a protocol that enables exchange of information on the World Wide Web (WWW). The HTTP is used in exchanging a HyperText Markup Language (HTML) document. The HTTP refers to a request and response protocol between a client and a server. For example, when a web browser that is the client requests the server 200 for a web page (HTML) or picture information via the HTTP, the server 200 may transmit required information to the client, in response to the request. The client may be include in the electronic device 100.

The display 120 may output an image or data processed by the electronic device 100. Referring to FIG. 2, it is shown that the electronic device 100 includes the display 120, but the disclosure is not necessarily limited thereto. The electronic device 100 may not include the display 120 or may include a simple display for notification. In this regard, the electronic device 100 may output a video via a separate TV or monitor via a video/audio output port, etc. Also, the electronic device 100 may output a video via a separate TV or monitor via wireless communication, etc.

The display 120 may display video content from various sources. For example, the display 120 may receive and display video content from various sources including a tuner, HDMI, over-the-top (OTT), etc.

The memory 130 may store a program for processing and controlling by the processor 140, and may store data input to the electronic device 100 or data output from the electronic device 100. Also, the memory 130 may store a plurality of pieces of data required for operations of the electronic device 100.

The memory 130 may include at least one type of storage medium from among flash memory, a hard disk, a multimedia card micro, a memory card (e.g., a secure digital (SD) or extreme digital (XD) memory card), random access memory (RAM), static random access memory (SRAM), read-only memory (ROM), electrically erasable programmable read-only memory (EEPROM), programmable read-only memory (PROM), magnetic memory, a magnetic disk, and an optical disc.

The processor 140 may include various processing circuitry and controls operations of the electronic device 100. For example, the processor 140 may execute one or more instructions stored in the memory 130 to perform functions of the electronic device 100 which are described in the disclosure.

The processor 140 may include various types of processing circuitry and/or a plurality of processors. For example, the term “processor” used herein may include various types of processing circuitry including at least one processor. One or more processors in the at least one processor may be configured to individually in a distributed manner or collectively perform various functions to be described here. As used herein, “processor”, “at least one processor”, and “one or more processors” may be configured to perform various functions. However, the recited terms cover a situation in which one processor performs a part of functions and other processor(s) performs the other part of the functions, and a situation in which one processor may perform all functions. Also, the at least one processor may include a combination of processors configured to perform a variety of the disclosed functions in a distributed manner. The at least one processor may execute program instructions to achieve or perform various functions.

In an embodiment of the disclosure, the processor 140 may store one or more instructions in an internal memory thereof, and may execute the one or more instructions stored in the internal memory to cause operations of the electronic device 100 to be performed. For example, the processor 140 may execute at least one instruction stored in an internal memory provided in the processor 140 or the memory 130 to perform a specified operation.

According to an embodiment of the disclosure, the processor 140 may execute the one or more instructions stored in the memory 130 to perform operations of the electronic device 100 which are disclosed in the disclosure.

According to an embodiment of the disclosure, the one or more instructions, when executed by the at least one processor 140 individually or collectively, may cause the electronic device 100 to, when a playback request for a channel providing live streaming content is received, obtain, from a server, a plurality of segments based on an index file corresponding to the channel.

According to an embodiment of the disclosure, the one or more instructions, when executed by the at least one processor 140 individually or collectively, may cause the electronic device 100 to determine whether there is most-recent segment information stored in correspondence with the channel, the most-recent segment information including information about a segment that was most recently played back in a previous playback on the channel.

According to an embodiment of the disclosure, the one or more instructions, when executed by the at least one processor 140 individually or collectively, may cause the electronic device 100 to, in a case where there is the most-recent segment information, identify a playback start segment using the most-recent segment information and information about a segment specified based on the index file.

According to an embodiment of the disclosure, the one or more instructions, when executed by the at least one processor 140 individually or collectively, may cause the electronic device 100 to play back the identified playback start segment.

According to an embodiment of the disclosure, the one or more instructions, when executed by the at least one processor 140 individually or collectively, may cause the electronic device 100 to, in a case where there is the most-recent segment information, when a segment number of the segment specified based on the index file is equal to or less than a segment number of the most-recent segment, identify, as the playback start segment, a segment corresponding to a next segment number subsequent to the segment number of the most-recent segment.

According to an embodiment of the disclosure, the one or more instructions, when executed by the at least one processor 140 individually or collectively, may cause the electronic device 100 to, when the segment number of the segment specified based on the index file is greater than the segment number of the most-recent segment, identify, as the playback start segment, the segment specified based on the index file.

According to an embodiment of the disclosure, the one or more instructions, when executed by the at least one processor 140 individually or collectively, may cause the electronic device 100 to, in a case where the most-recent segment information does not exist, identify, as the playback start segment, the segment specified based on the index file.

According to an embodiment of the disclosure, the segment specified based on the index file may indicate a segment corresponding to a segment number that is located at a specified position from among segment numbers of the plurality of segments included in the index file.

According to an embodiment of the disclosure, the one or more instructions, when executed by the at least one processor 140 individually or collectively, may cause the electronic device 100 to, when a playback end request for the channel is received, store a segment number of a segment most recently played back on the channel as the most-recent segment information corresponding to the channel.

According to an embodiment of the disclosure, the index file may include information about each of the plurality of segments, the information about each segment includes a URL for obtaining each segment, and the index file may include information indicating a segment number of each segment.

According to an embodiment of the disclosure, the one or more instructions, when executed by the at least one processor 140 individually or collectively, may cause the electronic device 100 to transmit a request to the server using a URL for each segment of the plurality of segments included in the index file, and may receive, from the server, the plurality of segments corresponding to the index file.

According to an embodiment of the disclosure, the one or more instructions, when executed by the at least one processor 140 individually or collectively, may cause the electronic device 100 to periodically request the server for the index file and receive an updated index file from the server.

According to an embodiment of the disclosure, the one or more instructions, when executed by the at least one processor 140 individually or collectively, may cause the electronic device 100 to receive, from the server, an updated plurality of segments based on the updated index file.

The electronic device 100 may be a device including a processor and memory and configured to perform a function. The electronic device 100 may be a stationary device or a portable device. For example, the electronic device 100 may indicate a device including a display and configured to display image content, video content, game content, graphic content, etc. The electronic device 100 may include, for example, any type of electronic device capable of receiving an outputting content, for example, a TV such as a network TV, a smart TV, an Internet TV, a web TV, or an Internet protocol (IP) TV, a computer such as a desktop computer, a laptop computer, or a tablet computer, or a smart device such as a smartphone, a cellular phone, a game player, a music player, a vide player, a medical device, or a home appliance. The electronic device 100 may be referred to as a display device as it can receive and display content, and may also be referred to as a content receiver, a sink device, a computing device, or the like.

A block diagram of the electronic device 100 shown in FIG. 2 is a block diagram according to an example embodiment of the disclosure. Each element of the block diagram may be combined, added, or omitted according to an actual specification of the electronic device 100. For example, when required, two or more elements may be combined into one element, or one element may be divided into two or more elements. Also, a function performed by each block may be for descriptions of embodiments of the disclosure, and particular operations or devices therefor do not limit the scope of the disclosure.

While FIG. 2 shows the electronic device 100 that includes a display, the disclosure is not limited thereto. For example, the electronic device 100 may be a device for proving content to an external display device including a display. The content may include an image, a video, audio, text, a game, an application, or the like, and the disclosure is not limited thereto. For example, the electronic device 100 may include a set-top box (STB), a Blu-ray disc player, a digital versatile disc (DVD) player), a game console, a digital camera, a camcorder, a streaming device, a home theater, or the like. In this case, the electronic device 100 may be connected to an external display device via an input/output unit such as a HDMI port, etc. and may be configured to transmit video/audio signals to the external display device. The electronic device 100 and the external display device may be connected to each other via wired communication, short-range wireless communication including a wireless local area network (W-LAN), Wi-Fi, Bluetooth, etc., or long-range wireless communication.

The server 200 may include a communication interface (e.g., including communication circuitry) 210, a memory 220, and a processor (e.g., including processing circuitry) 230. However, the server 200 may be implemented with more elements than the shown elements, and is not limited thereto.

The communication interface 210 may include various communication circuitry included in one or more modules that enable wireless communication between the server 200 and a wireless communication system or between the server 200 and a network in which other device is located. According to an embodiment of the disclosure, the communication interface 210 may perform communication with the electronic device 100 according to Internet protocol.

The memory 220 may store a program for processing and controlling by the processor 230, and may store data input to the server 200 or data output from the server 200.

The memory 220 may include at least one type of storage medium from among flash memory, a hard disk, a multimedia card micro, a memory card (e.g., a SD or XD memory card), a RAM, a SRAM, a ROM, an EEPROM, a PROM, a magnetic memory, a magnetic disk, and an optical disc.

The processor 230 includes various types of processing circuitry for controlling operations of the server 200. For example, the processor 230 may execute one or more instructions stored in the memory 220 to perform functions of the server 200 described in the disclosure.

According to an embodiment of the disclosure, the processor 230 may store one or more instructions in an internal memory thereof, and may execute the one or more instructions stored in the internal memory to control the afore-described operations to be performed. For example, the processor 230 may execute at least one instruction or program stored in the internal memory of the processor 230 or stored in the memory 220 to perform a specified operation.

According to an embodiment of the disclosure, the processor 230 may execute one or more instructions stored in the memory 220 to receive a request for channel content from the electronic device 100 and transmit, to the electronic device 100, an index file corresponding to a requested channel.

According to an embodiment of the disclosure, the processor 230 may execute one or more instructions stored in the memory 220 to receive a transmission request for a segment included in the index file from the electronic device 100 and transmit the requested segment to the electronic device 100.

A block diagram of the server 200 shown in FIG. 2 is a block diagram for an embodiment of the disclosure. Each element of the block diagram may be combined, added, or omitted according to an actual specification of the server 200. For example, when required, two or more elements may be combined into one element, or one element may be divided into two or more elements. A function performed by each block may be for descriptions of various example embodiments of the disclosure, and particular operations or devices therefor do not limit the scope of the disclosure.

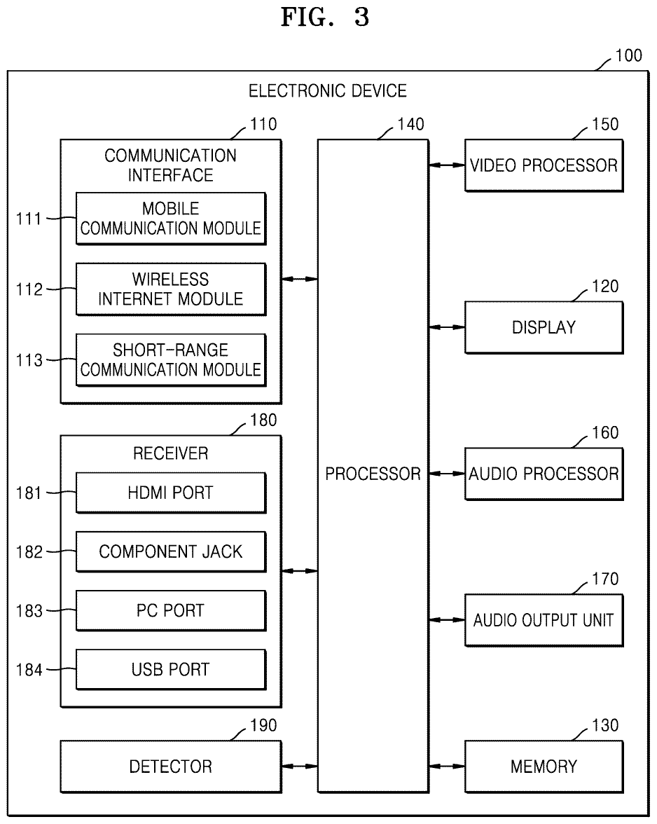

FIG. 3 is a block diagram illustrating an example configuration of an electronic device according to various embodiments.

Referring to FIG. 3, the electronic device 100 may include a video processor (e.g., including video processing circuitry) 150, an audio processor (e.g., including audio processing circuitry) 160, an audio output unit (e.g., including audio output circuitry) 170, a receiver 180, and a detector 190, as well as the communication interface (e.g., including communication circuitry) 110, the display 120, the memory 130, and the processor (e.g., including processing circuitry) 140.

The communication interface 110 may include various types of communication circuitry included in one or more modules configured to enable a wireless communication between the electronic device 100 and a wireless communication system or between the electronic device 100 and a network including other electronic device. For example, the communication interface 110 may include a mobile communication module 111, a wireless Internet module 112, and a short-range communication module 113.

The mobile communication module 111 transmits and receives wireless signals to and from at least one of a base station, an external terminal, or a server in a mobile communication network. The wireless signals may include various types of data based on transmission and reception of voice call signals, video call signals, or text/multimedia messages.

The wireless Internet module 112 indicates a module for accessing wireless Internet, and may be arranged inside or outside the electronic device 100. As the wireless Internet technology, Wireless Local Area Network (WLAN including Wi-Fi), Wireless broadband (WiBro), World Interoperability for Microwave Access (WiMax), High Speed Downlink Packet Access (HSDPA), or the like may be used. The electronic device 100 may perform Wi-Fi peer to peer (P2P) connection to other device via the wireless Internet module 112. The wireless Internet module 112 may be used to communicate with a broadcasting server 300.

The short-range communication module 113 indicates a module for a short-range communication. As the short-range communication technology, Bluetooth, BLE, RFID, infrared Data Association (IrDA), UWB, ZigBee, etc. may be used. The short-range communication module 113 may be used to communicate with the input device.

The display 120 may display, on a screen, a video signal received from the server 200.

The memory 130 may store a program related to an operation of the electronic device 100, and various data occurring during the operation of the electronic device 100.

The memory 130 may store at least one instruction. Also, the memory 130 may store at least one program to be executed by the processor 140. Also, the memory 130 may store at least one program to be executed by the processor 140. Also, the memory 130 may store an application for providing a specified service.

For example, the memory 130 may include at least one type of storage medium from among flash memory, a hard disk, a multimedia card micro, a memory card (e.g., a SD or XD memory card), a RAM, a SRAM, a ROM, an EEPROM, a PROM, a magnetic memory, a magnetic disk, and an optical disc.

The processor 140 controls various operations of the electronic device 100. For example, the processor 140 may execute one or more instructions stored in the memory 130 to perform functions of the electronic device 100 described in the disclosure.

The processor 140 may include various types of processing circuitry and/or a plurality of processors. For example, the term “processor” used herein including claims may include various types of processing circuitry including at least one processor. One or more processors in the at least one processor may be configured to individually in a distributed manner or collectively perform various functions to be described here. As used herein, “processor”, “at least one processor”, and “one or more processors” may be configured to perform various functions. However, the recited terms cover a situation in which one processor performs a part of functions and other processor(s) performs the other part of the functions, and a situation in which one processor may perform all functions. Also, the at least one processor may include a combination of processors configured to perform a variety of the disclosed functions in a distributed manner. The at least one processor may execute program instructions to achieve or perform various functions.

In an embodiment of the disclosure, the processor 140 may store one or more instructions in an internal memory thereof, and may execute the one or more instructions stored in the internal memory to cause operations of the electronic device 100 to be performed. That is, the processor 140 may execute at least one instruction stored in an internal memory provided in the processor 140 or the memory 130 to perform a specified operation.

The video processor 150 may include various video processing circuitry and process a video signal received from the receiver 180 or the communication interface 110 and may output the video signal to the display 120, based on control by the processor 140. The video processor 150 may include various types of processing circuitry.

The audio processor 160 may include various audio processing circuitry and convert an audio signal received from the receiver 180 or the communication interface 110 into an analog audio signal and may output the analog audio signal to the audio output unit 170, based on control by the processor 140. The audio processor 160 may include various types of processing circuitry.

The audio output unit 170 may include various output circuitry and output audio (e.g., a voice, sound) input via the communication interface 110 or the receiver 180. The audio output unit 170 may output audio stored in the memory 130, based on control by the processor 140. The audio output unit 170 may include at least one of a speaker, a headphone output terminal, or a Sony/Philips digital interface (S/PDIF) terminal or a combination thereof.

The receiver 180 may include various circuitry and receive video (e.g., a moving picture, etc.), audio (e.g., speech, music, etc.), and auxiliary information (e.g., electronic program guide (EPG)) from the outside of the electronic device 100, based on control by the processor 140. The receiver 180 may include one of a HDMI port 181, a component jack 182, a PC port 183, and a USB port 184, or a combination thereof. The receiver 180 may further include a display port (DP), a Thunderbolt port, a mobile high-definition link (MHL), as well as the HDMI port 181. In addition, the receiver 180 may further include ports for separate outputs of a video signal and an audio signal.

The detector 190 may include various circuitry and detects speech of a user, a video of the user, or an interaction of the user, and may include a microphone, a camera, and a light receiver.

The microphone receives speech uttered by the user. The microphone may convert the received speech into an electric signal and output the electric signal to the processor 140. The user's speech may include, for example, speech corresponding to a menu or function of the electronic device 100. The microphone may be provided not only at the electronic device 100 but also at a smartphone or a remote controller, and the electronic device 100 may receive, via Bluetooth communication or Wi-Fi communication, a voice signal received via the smartphone or a microphone of the remote controller.

The camera may receive a video (e.g., consecutive frames) corresponding to motion of a user including a gesture within a camera recognition range. The processor 140 may select a menu displayed on the electronic device 100 using a received motion recognition result or may perform control corresponding to the motion recognition result.

The light receiver receives an optical signal (including the control signal) received from an external control device. The light receiver may receive an optical signal corresponding to a user input (e.g., touch, press, touch gesture, speech, or motion) from a control device. The control signal may be extracted from the received optical signal, based on control by the processor 140.

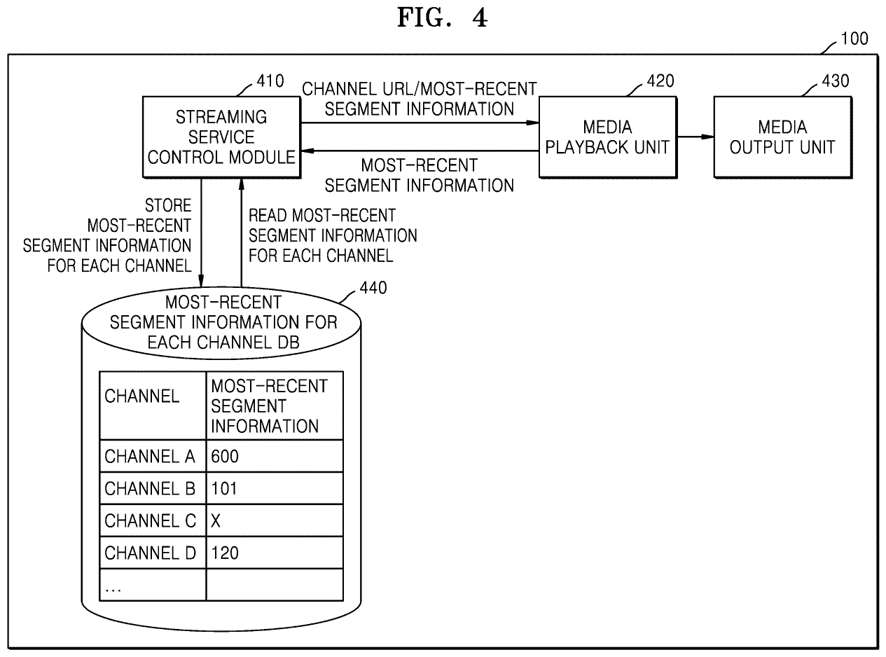

FIG. 4 is a block diagram illustrating an example function of an electronic device according to various embodiments.

Referring to FIG. 4, the electronic device 100 may include a streaming service control module (e.g., including various circuitry and/or executable program instructions) 410, a media playback unit (e.g., including various circuitry and/or executable program instructions) 420, a media output unit (e.g., including various circuitry and/or executable program instructions) 430, and most-recent segment information for each channel database (DB) 440 (hereinafter, also referred to as the DB 440).

The streaming service control module 410 may include at least one of logic, circuitry, an interface, or code which may appropriately operate to manage playback of live streaming content according to an embodiment of the disclosure. According to an embodiment of the disclosure, the streaming service control module 410 may be included in the memory 130.

According to an embodiment of the disclosure, in response to a playback end of channel content played back in the media playback unit 420, the streaming service control module 410 may receive most-recent segment information that is most recently played back on a corresponding channel, and may store the received most-recent segment information in the most-recent segment information for each channel DB 440.

According to an embodiment of the disclosure, when a playback request for a channel is received, the streaming service control module 410 may transmit a URL of the playback requested channel to the media playback unit 420. When there is most-recent segment information corresponding to the playback requested channel, the streaming service control module 410 may transmit both the URL of the channel and the most-recent segment information stored in correspondence with the channel to the media playback unit 420.

The media playback unit 420 may include at least one of logic, circuitry, an interface, or code which may appropriately operate to receive and play back content of a channel that provides live streaming content. According to an embodiment of the disclosure, the media playback unit 420 may be included in the video processor 150 or the audio processor 160.

According to an embodiment of the disclosure, in response to the playback request for the channel providing live streaming content, the media playback unit 420 may receive the URL of the playback requested channel from the streaming service control module 410, and may receive and play back live streaming content provided by the channel, using the URL of the channel.

According to an embodiment of the disclosure, in response to the playback request for the channel providing live streaming content, the media playback unit 420 may receive the URL of the playback requested channel and the most-recent segment information of the channel from the streaming service control module 410 The media playback unit 420 may more precisely select a playback start segment using the most-recent segment information of the playback requested channel.

The media output unit 430 may output audio and video data played back by the media playback unit 420. The media output unit 430 may include, for example, at least one of the display 120 or the audio output unit 170.

The most-recent segment information for each channel DB 440 may store most-recent segment information for each channel that provides live streaming content. The most-recent segment information for each channel DB 440 may be included in the memory 130.

Most-recent segment information for each channel may include a segment number of a most-recent segment that was played back on a corresponding channel. For example, when playback ends while segment 600 is played back on channel A, 600 may be stored as most-recent segment information corresponding to channel A. For example, when playback ends while segment 101 is played back on channel B, 101 may be stored as most-recent segment information corresponding to channel B. When channel C has never been played back, most-recent segment information therefor may not exist. For example, when playback ends while segment 120 is played back on channel D, 120 may be stored as most-recent segment information corresponding to channel D.

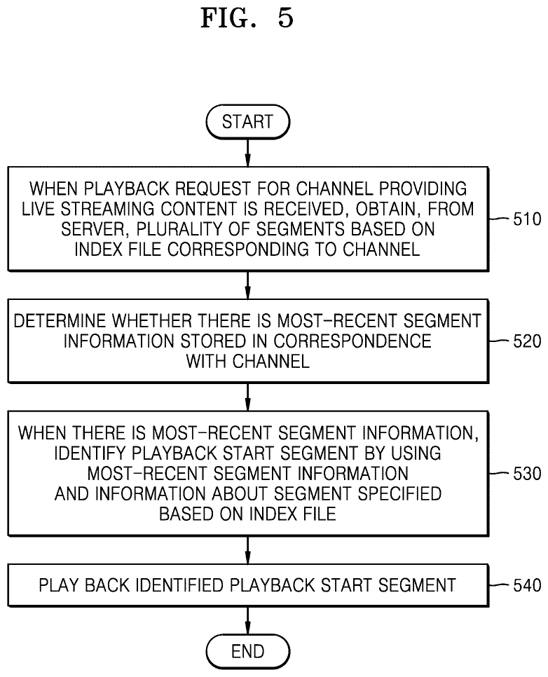

FIG. 5 is a flowchart illustrating an example method of operating an electronic device, according to various embodiments.

Referring to FIG. 5, in operation 510, when a playback request for a channel providing live streaming content is received, the electronic device 100 may obtain, from a server, a plurality of segments based on an index file corresponding to the channel.

According to an embodiment of the disclosure, when an input (e.g., a user input) of selecting a channel providing live streaming content is received, the electronic device 100 may receive a playback request for the channel.

According to an embodiment of the disclosure, the electronic device 100 may access the server 200 providing live streaming content, may select a live streaming content channel provided by the server 200, and thus, may receive a playback request for the channel.

According to an embodiment of the disclosure, the electronic device 100 may request the server 200 for an index file corresponding to a playback requested channel, and may receive the index file from the server 200. An index file corresponding to a channel may include information about a plurality of segments including live streaming content provided by the channel. Information about each segment may include a URL for obtaining each segment. The index file may include a segment number of each segment.

According to an embodiment of the disclosure, the electronic device 100 may obtain the plurality of segments from the server 200 using the information about the plurality of segments included in the index file.

According to an embodiment of the disclosure, the electronic device 100 may receive an updated index file from the server 200 by periodically requesting the server 200 for an index file, and may receive an updated plurality of segments based on the updated index file from the server 200.

In operation 520, the electronic device 100 may determine whether there is most-recent segment information stored in correspondence with the channel. The most-recent segment information stored in correspondence with the channel may include information about a segment that was most recently played back in a previous playback on the channel. For example, when a playback end request occurs while segment 100 is played back in correspondence with channel A, the electronic device 100 may store segment 100 as most-recent segment information in correspondence with channel A. Afterward, when a playback request for channel A occurs again, the electronic device 100 may determine that there is the most-recent segment information stored in correspondence with channel A. In a case of a channel that was never been played back, most-recent segment information stored in response to the channel may not exist.

In operation 530, when there is the most-recent segment information, the electronic device 100 may identify a playback start segment using the most-recent segment information and information about a segment specified based on the index file.

The index file may include information about the plurality of segments. The information about the segment specified based on the index file may include information about a predetermined (e.g., specified) particular segment in the information about the plurality of segments included in the index file. For example, the index file may include segment numbers of the plurality of segments, and the information about the specified segment may include a segment number of a segment at a particular position in the order from among the segment numbers of the plurality of segments. For example, when the index file includes segment numbers of six (6) segments, the information about the specified segment may indicate a segment number of a 3^{rd} segment from the end from among the segment numbers of the plurality of segments

According to an embodiment of the disclosure, when there is the most-recent segment information, the electronic device 100 may identify a playback start segment using a segment number of a most-recent segment and a segment number specified based on the index file.

According to an embodiment of the disclosure, when the segment number specified based on the index file is greater than the segment number of the most-recent segment stored in correspondence with the channel, the electronic device 100 may identify, as the playback start segment, the segment number specified based on the index file.

According to an embodiment of the disclosure, when the segment number specified based on the index file is equal to or less than the segment number of the most-recent segment stored in correspondence with the channel, the electronic device 100 may identify, as the playback start segment, a segment corresponding to a segment number next to the segment number of the most-recent segment.

According to an embodiment of the disclosure, when there is no most-recent segment information, the electronic device 100 may identify, as the playback start segment, the segment specified based on the index file.

In operation 540, the electronic device 100 may play back the identified playback start segment.

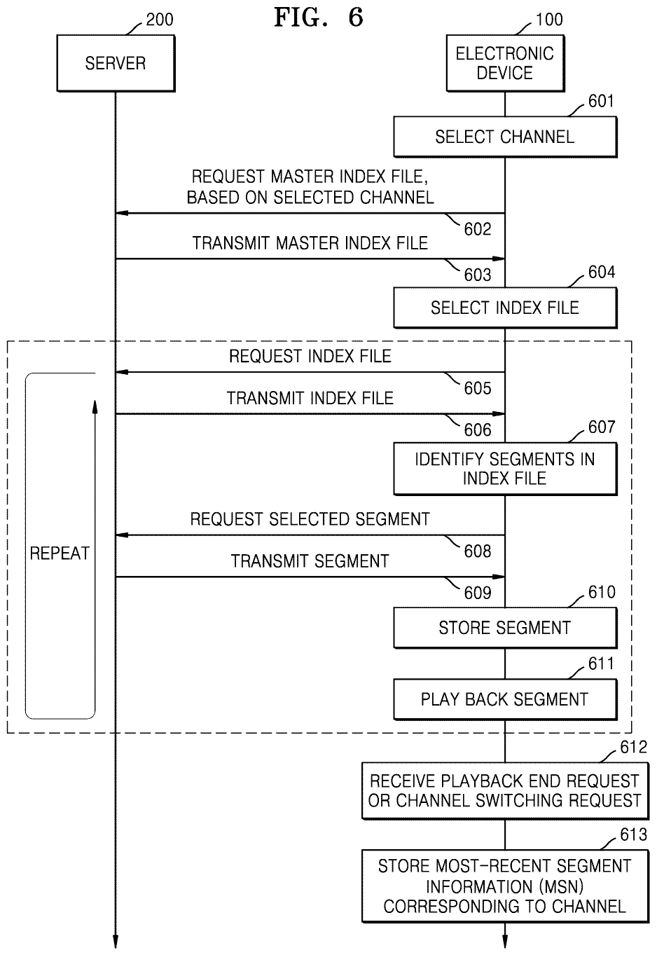

FIG. 6 is a signal flow diagram illustrating an example method of operating an electronic device, according to various embodiments.

Referring to FIG. 6, in operation 601, the electronic device 100 may receive an input of selecting a channel providing live streaming content. For example, the electronic device 100 may output a user interface including channels provided by the server 200, and may receive a user input of selecting one channel from the user interface.

In operation 602, the electronic device 100 may request the server 200 for a master index file, based on the selected channel. The master index file informs existence of various profiles, e.g. bitrate versions, with respect to a live streaming content video provided by the channel.

In operation 603, the electronic device 100 may receive the master index file corresponding to the selected channel from the server 200.

In operation 604, the electronic device 100 may select an index file, based on the master index file.

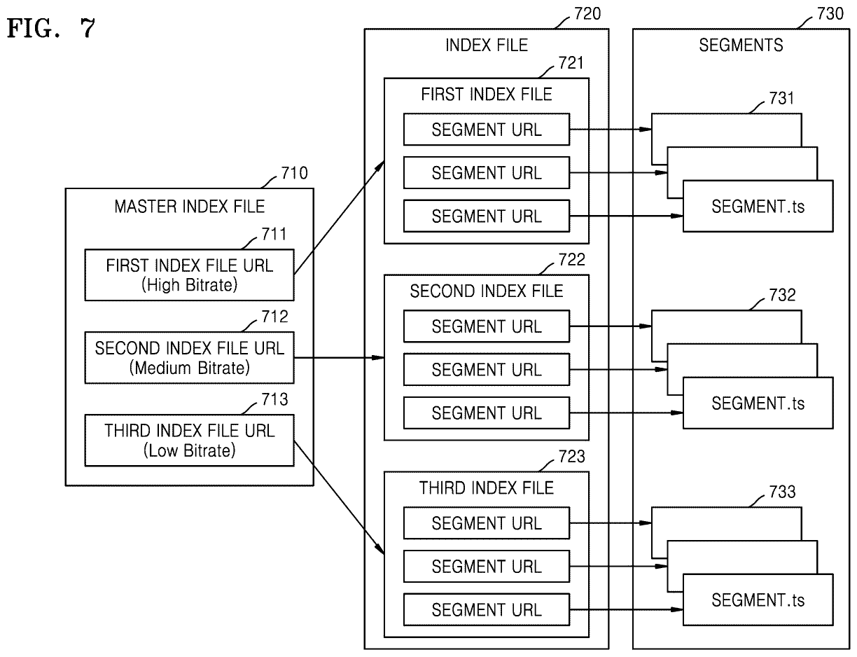

FIG. 7 is a diagram illustrating an example of a master index file and an index file, according to various embodiments.

A master index file 710 may specify substitute streams of content. An index, i.e., the master index file 710 may include index file URLs used to obtain substitute streams. The substitute streams may refer to streams of various qualities for different bandwidths or different devices with respect to same content.

Referring to FIG. 7, the master index file 710 may include a first index file URL 711 providing a high bitrate stream, a second index file URL 712 providing a medium bitrate stream, and a third index file URL 713 providing a low bitrate stream.

The electronic device 100 may select an index file URL appropriate for a situation of the electronic device from among the index file URLs included in the master index file 710.

The electronic device 100 may receive an index file 720 using an index file URL included in the master index file 710, and may receive segments 730 using an index file URL included in the index file 720.

Referring back to FIG. 6, in operation 605, the electronic device 100 may request the server 200 for the selected index file. The electronic device 100 may request the server 200 for the index file using the index file URL selected from the master index file.

In operation 606, the electronic device 100 may receive the requested index file from the server 200.

In operation 607, the electronic device 100 may identify the index file received from the server 200, and in operation 608, may request segments specified in the index file.

In operation 609, the electronic device 100 may receive the requested segments from the server 200.

In operation 610, the electronic device 100 may store the received segments.

With reference to FIG. 7, an index file and a segment will now be described.

Referring to FIG. 7, for example, when the electronic device 100 requests the server 200 for a first index file using a first index file URL included in the master index file 710, the electronic device 100 may receive a first index file 721 from the server 200. The first index file 721 may include information about a plurality of segments. Information about a segment may include a URL for obtaining the segment. The electronic device 100 may request the server 200 for the plurality of segments using URLs with respect to the plurality of segments. Accordingly, the electronic device 100 may receive a plurality of segments 731 specified in the first index file 721. Similarly, the electronic device 100 may receive a plurality of segments 732 specified in the second index file 722 received using the second index file URL 712. Likewise, the electronic device 100 may receive a plurality of segments 733 specified in the third index file 723 received using the third index file URL 713.

In operation 611, the electronic device 100 may play back the segments.

Both a master index file and an index file may have an m3u8 format. The master index file may be downloaded only once, and the index file may be periodically downloaded for live streaming. For example, as the server 200 divides a portion of live content as the live content becomes available for live streaming into segments in a specified unit, and transmits URLs of the divided segments by inserting them into an index file, the electronic device 100 may periodically receive the index file, and may obtain the segments using the URLs of the segments in the index file. That is, while a live streaming content channel is played back, the electronic device 100 may repeatedly perform operation 605 to operation 611.

In operation 612, the electronic device 100 may receive a playback termination request or a channel switching request. For example, the electronic device 100 may receive a request to terminate the playback of content from the currently selected channel, or a request to switch channels from the user.

In operation 613, the electronic device 100 may store the last segment information, for example most-recent segment information (MSN) corresponding to the channel. Based on such a channel termination request or channel switching request, the electronic device 100 may store information about the last segment that was being played on the current channel. This last segment information may indicate the most recently played segment on the current channel.

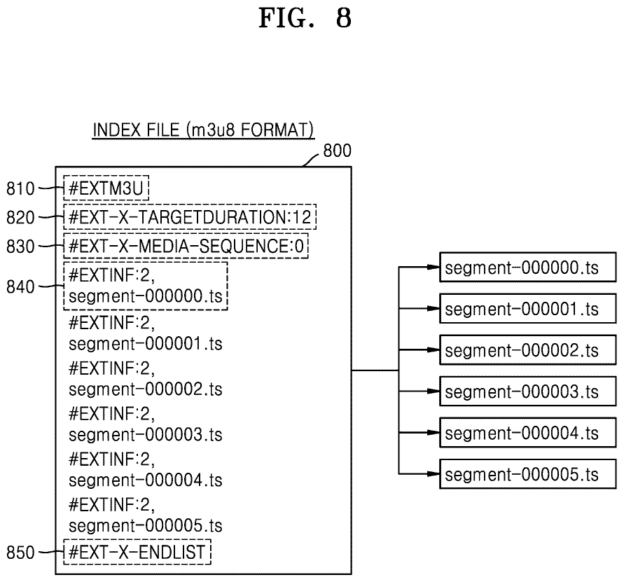

FIG. 8 is a diagram illustrating an example of an index file according to various embodiments.

Referring to FIG. 8, an index file 800 has an m3u8 format. The term “m3u8” refers to a file format of a multimedia playlist.

#EXTM3U 810 is specified at the first row of the index file, and defines that this index file has an m3u8 format.

#EXT-X-TARGETDURATION: <time: second> 820 specifies a maximum playback duration of each of files listed in a file list.

#EXT-X-MEDIA-SEQUENCE: <serial number of first file> 830 specifies a serial number of a first file from among the files listed in the index file. From the segment number of the first segment specified as #EXT-X-MEDIA-SEQUENCE 830 of the index file, segment numbers of other segments may be estimated. For example, a segment number specified as #EXT-X-MEDIA-SEQUENCE is the segment number of the first segment, and segment numbers of subsequent segments increase sequentially by one from the segment number of the first segment. For example, as in the example of FIG. 8, when there are files of 0, 1, 2, 3, 4, and 5, a value of this directive is 0.

#EXTINF: <playback duration: seconds>, <title> 840 indicates that content specified after this directive has a playback duration of 2 seconds and a file name is segment-000000.ts.

#EXT-X-ENDLIST 850 indicates that there is no more content to be played back in the play list.

When receiving the index file, the electronic device 100 may receive each segment from the server 200 using each segment URL included in the index file 800. The index file 800 may include URLs of 6 segments from segments 0 to 5, and the electronic device 100 may obtain a total of 6 segments, based on the index file 800. The electronic device 100 may determine a playback start segment as a segment at a predetermined position in the order from among the obtained segments. For example, the electronic device may start playback at the 3^{rd} segment from the end in the order of segment numbers included in the index file. Due to a characteristic of live streaming, as the server 200 generates and transmits a live video in real time and the electronic device 100 receives the live video in the form of segments, a segment at the beginning of a sequence of segment numbers included in the index file 800 may correspond to video content that is earlier in time than a current point of the live video, that is, a video that has already passed, and therefore, in order to start playback as close as possible to the current point of the live video, a segment located around the middle of the sequence of segment numbers may be selected as the playback start segment. Also, when playback starts from a segment located too close to the end of the sequence of segment numbers, there may be insufficient time to read a next index file and receive segments based on the next index file. In consideration of the above factors, the electronic device 100 may identify a segment number located at an appropriate position in the sequence of segment numbers of the index file 800 as a segment number of the playback start segment.

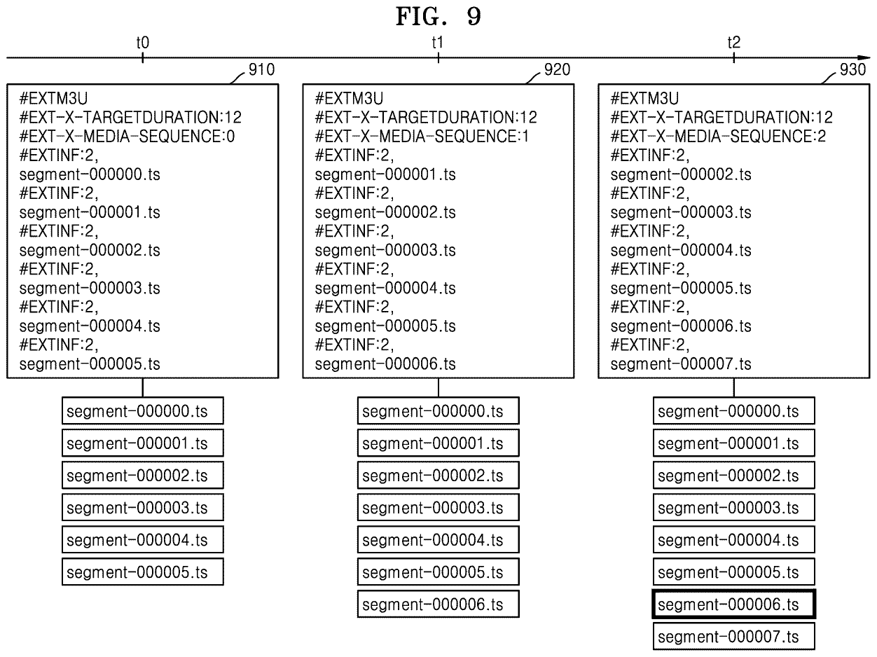

With reference to FIG. 9, a method of periodically updating an index file and obtaining a segment will now be described in greater detail.

FIG. 9 is a diagram illustrating an example of an index file that is received periodically, according to various embodiments.

Referring to FIG. 9, for example, the electronic device may receive an index file 910 at t0 point in time, and may receive, from the server 200, segment 0 to segment 5 using URLs of segment 0 to segment 5 included in the index file 910. The electronic device 100 may start playback from a segment specified as a playback start segment from among segment numbers included in the index file 910. For example, when it is assumed that the electronic device 100 starts playback from the 3^{rd} segment from the end among the segment numbers of in the index file 910, the electronic device 100 may start playback from segment 3. When playback starts from a segment with a segment number located earlier in the index file 910, for example, from segment number 0, a video that is too earlier than a currently broadcast video may be played back. For example, in a case of watching a live broadcast of a soccer match, while a neighbor may be cheering after watching a goal, a user may still be watching a scene before the goal was scored. When playback starts from a segment with a later segment number in the index file 910, for example, segment 5, a video being played back will have the smallest time difference from current live content, which is good for real-time performance, however, there may not be enough time to read a next index file 920 and play back subsequent segment 6. Therefore, for example, the electronic device 100 may identify a segment number located in the middle from among segment numbers included in the index file 910 as a playback start segment. A segment from which playback starts may be determined in various manners.

The electronic device 100 may periodically update an index file. For example, the electronic device 100 may receive the index file 920 at t1 point in time. As segment 0 to segment 5 from among segment numbers included in the index file 920 are segments that are already stored, the electronic device 100 may receive segment 6 using a URL of segment 6 from the server 200.

The electronic device 100 may receive an index file 930 at t2 point in time. As segment 0 to segment 6 from among segment numbers included in the index file 930 are segments that are already stored, the electronic device 100 may receive segment 7 using a URL of segment 7 from the server 200.

In this manner, the electronic device 100 may periodically receive an index file from the server 200 and may receive, using streaming, segments using segment numbers included in the index file, thereby obtaining live streaming content.

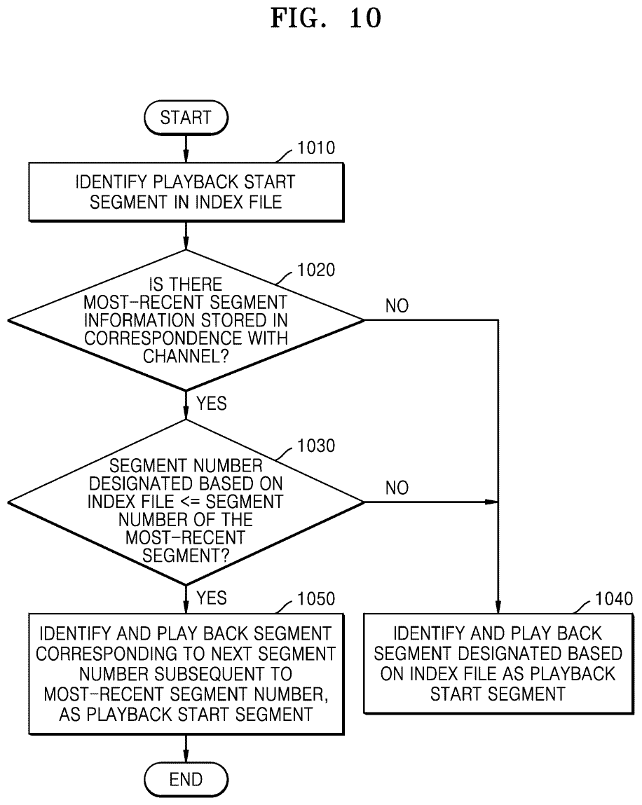

FIG. 10 is a flowchart illustrating an example method of operating an electronic device according to various embodiments. Operations shown in FIG. 10 may indicate example operations of operation 611 related to segment playback among operations shown in FIG. 6.

Referring to FIG. 10, in operation 1010, the electronic device 100 may identify a segment specified based on an index file.

The index file may include a series of segment numbers, and which segment to start playback from among the series of segment numbers may be determined according to a protocol or various policies. When playback starts from an earlier segment having an earlier segment number among the segment numbers included in the index file, there may be a significant time difference from a video currently being broadcast live, and when playback starts from a later segment having a later segment number, there may not be enough time to update the index file and store a next segment in the order. Therefore, for example, the electronic device 100 may identify a segment number located Nth from the end among a plurality of segment numbers included in the index file as the segment specified based on the index file. For example, in the example of FIG. 10, segment 3 that is a 3^{rd} segment number from the end in the index file 910 may be identified as the segment specified based on the index file.

In operation 1020, the electronic device 100 may determine whether there is most-recent segment information stored in correspondence with a channel.

The most-recent segment information stored in correspondence with the channel may indicate a segment number that was most recently played back when the channel was previously played back. For example, in the example of FIG. 10, when playback of the channel is ended while segment 6 is played back, the most-recent segment information may be segment 6. In a case of a channel that was never been played back, most-recent segment information stored in response to the channel may not exist.

As a result of the determination in operation 1020, when there is no most-recent segment information stored in correspondence with the channel, operation 1040 may be performed.

In operation 1040, when there is no most-recent segment information stored in correspondence with the channel, it may indicate that the channel is not a channel that was previously played back and then stopped or ended, the electronic device 100 may identify and play back the segment specified based on the index file as a playback start segment.

As a result of the determination in operation 1020, when there is the most-recent segment information stored in correspondence with the channel, operation 1030 may be performed.

In operation 1030, the electronic device 100 may determine whether a segment number of the segment specified based on the index file is equal to or less than a segment number of a most-recent segment stored in correspondence with the channel.

As a result of the determination in operation 1030, when the segment number of the segment specified based on the index file is greater than the segment number of the most-recent segment stored in correspondence with the channel, operation 1040 may be performed.

In operation 1040, when the segment number of the segment specified based on the index file is greater than the segment number of the most-recent segment stored in correspondence with the channel, the electronic device 100 may identify and play back the segment specified based on the index file as a playback start segment.

In operation 1050, if the segment number of the segment specified based on the index file is equal to or less than the segment number of the most-recent segment stored in correspondence with the channel, the electronic device 100 may identify the segment corresponding to the next number after the last segment number as the playback start segment and play back the segment.

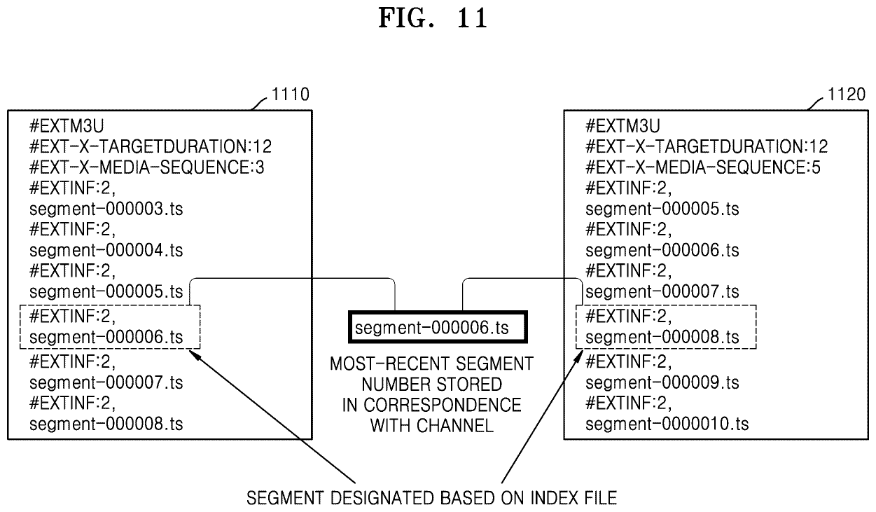

FIG. 11 is a diagram illustrating an example of a most-recent segment number and an index file, according to various embodiments.

Referring to FIG. 11, the most-recent segment number stored in correspondence with a channel is <6>. In an index file 1110 received to receive content of the channel, when the specified segment is a 3^{rd} segment from the end in the index file 1120, a segment number of a segment specified based on the index file is segment 8. Therefore, in this case, <8> that is the segment number of the segment specified based on the index file is greater than <6> that is the most-recent segment number stored in correspondence with the channel. In this case, as a segment to be played back based on the index file at a current point in time is a segment following a most-recent segment previously played on the channel, playing the segment as specified in the index file not affect a user experience, and thus, the electronic device 100 may start playback from segment 8 specified based on the index file.

As a result of the determination in operation 1030, when the segment number of the segment specified based on the index file is equal to or less than the segment number of the most-recent segment stored in correspondence with the channel, operation 1050 may be performed.

In operation 1050, the electronic device 100 may identify and play back, as a playback start segment, a segment corresponding to a next segment number subsequent to the most-recent segment number.

Referring to FIG. 11, the most-recent segment number stored in correspondence with the channel is <6>. In an index file 1110 received to receive content of the channel, when the specified segment is a 3^{rd} segment from the end in the index file 1110, a segment number of a segment specified based on the index file is segment 6. Therefore, in this case, <6> that is the segment number of the segment specified based on the index file is equal to <6> that is the most-recent segment number stored in correspondence with the channel. In this case, when segment 6 is played as is, segment 6, which was the most-recent segment previously played on the channel, would be played back again, and from the user perspective, this may give the user an impression that segment 6 is still being played back even after returning to the channel following channel switching, and thus, may provide an unnatural experience to the user. Therefore, in this case, the electronic device 100 may identify and play back, as a playback start segment, a segment corresponding to a next segment number subsequent to the most-recent segment number. That is, the electronic device 100 may identify and play back, as the playback start segment, segment 7 that is a next segment number subsequent to segment 6 as the most-recent segment number.

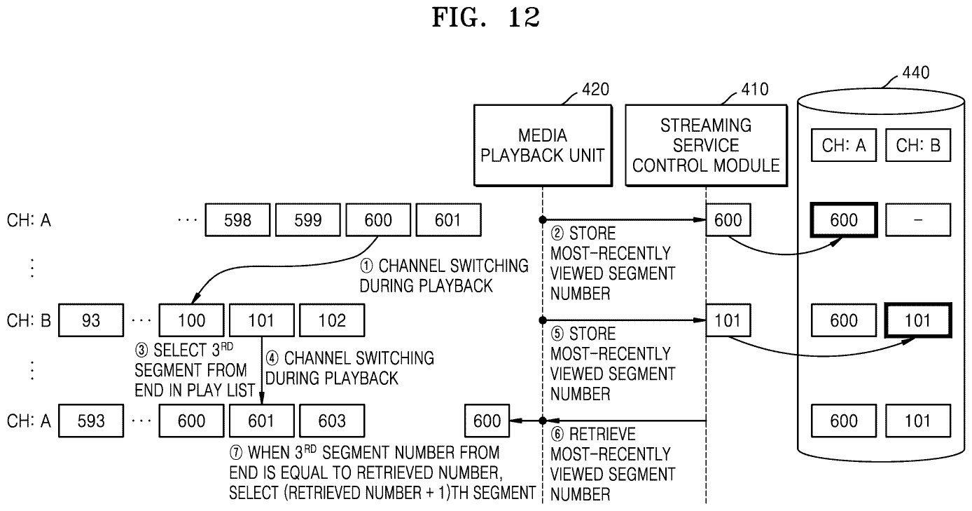

FIG. 12 is a diagram illustrating an example scenario in which a segment is naturally processed according to channel switching and returning, according to various embodiments.

Referring to FIG. 12, for example, the electronic device 100 may play back channel A. When a request for channel switching to channel B is received while segment 600 of channel A is played back, the media playback unit 420 of the electronic device 100 may transmit segment number 600, which is a segment number of a segment most recently viewed, to the streaming service control module 410 as most-recent segment information corresponding to channel A. The streaming service control module 410 may store, in the DB 440, segment 600 as most-recent segment information corresponding to channel A.

In response to receiving a request for channel switching to channel B, the electronic device 100 switches from channel A to channel B, and when referring to the DB 440, a most-recent segment number is not stored in correspondence with channel B. Therefore, the electronic device 100 may start playback of segment 100 that is a segment specified based on the index file. When the electronic device 100 receives again a channel switching request while playing back segment 101, the media playback unit 420 of the electronic device 100 may transmit segment number 101, which is a segment number of a segment most recently viewed, to the streaming service control module 410 as most-recent segment information corresponding to channel B. The streaming service control module 410 may store, in the DB 440, segment 101 as most-recent segment information corresponding to channel B.

In response to receiving a request for channel switching to channel A, the electronic device 100 switches from channel B to channel A, and when referring to the DB 440, segment 600 is stored as a most-recent segment number in correspondence with channel B. Therefore, the streaming service control module 410 may transmit, to the media playback unit 420, segment 600 stored as the most-recent segment number in correspondence with channel B. In response to channel switching from channel B to channel A, the media playback unit 420 may compare the index file with the most-recent segment number stored in correspondence with channel A, and thus, may determine a playback start segment. When a segment specified based on the index file is segment 602, because a segment number of segment 602 is greater than segment 600 that is a most-recent segment number that was previously played back on channel A, the media playback unit 420 may changelessly play back segment 602 that is segment specified based on the index file. When a segment specified based on the index file is segment 600, a segment number of segment 600 is equal to segment 600 that is the most-recent segment number that was previously played back on channel A. In this case, in order not to play back again segment 600 that was previously played back on channel A, the media playback unit 420 may start playback from segment 601 that is a segment number increased by one from the most-recent segment 600, so that it is possible to prevent or block segment 600 from being played back redundantly.

According to an embodiment of the disclosure, a method of operating an electronic device may include, based on a playback request for a channel providing live streaming content being received, obtaining, from a server, a plurality of segments based on an index file corresponding to the channel.

According to an embodiment of the disclosure, the method of operating the electronic device may include determining whether there is most-recent segment information stored in correspondence with the channel, the most-recent segment information including information about a segment that was most recently played back in a previous playback on the channel.

According to an embodiment of the disclosure, the method of operating the electronic device may include, based on the most-recent segment information existing, identifying a playback start segment using the most-recent segment information and information about a segment designated based on the index file.

According to an embodiment of the disclosure, the method of operating the electronic device may include playing back the identified playback start segment.

According to an embodiment of the disclosure, the method of operating the electronic device may include, based on the most-recent segment information existing, when a segment number of the segment designated based on the index file is equal to or less than a segment number of the most-recent segment, identifying, as the playback start segment, a segment corresponding to a next segment number subsequent to the segment number of the most-recent segment.

According to an embodiment of the disclosure, the method of operating the electronic device may include, when the segment number of the segment designated based on the index file is greater than the number of the most-recent segment, identifying, as the playback start segment, the segment designated based on the index file.

According to an embodiment of the disclosure, the method of operating the electronic device may include, based on the most-recent segment information not existing, identifying, as the playback start segment, the segment designated based on the index file.

According to an embodiment of the disclosure, the segment designated based on the index file may indicate a segment corresponding to a segment number that is located at a specified position from among segment numbers of the plurality of segments included in the index file.

According to an embodiment of the disclosure, the method of operating the electronic device may include, based on a playback end request for the channel being received, storing a segment number of a segment most recently played back on the channel as the most-recent segment information corresponding to the channel.

According to an embodiment of the disclosure, the index file may include information about each of the plurality of segments, the information about each segment includes a URL for obtaining each segment, and the URL may include information indicating a number of each segment.

According to an embodiment of the disclosure, the method of operating the electronic device may include transmitting a request to the server using a URL for each segment of the plurality of segments included in the index file, and receiving, from the server, the plurality of segments corresponding to the index file.

According to an embodiment of the disclosure, the method of operating the electronic device may include periodically requesting the server for the index file and receiving an updated index file from the server.

According to an embodiment of the disclosure, the method of operating the electronic device may include receiving, from the server, an updated plurality of segments based on the updated index file.

Various embodiments may be implemented as a computer-readable recording medium, e.g., a program module to be executed in computers, which includes computer-readable instructions. The computer-readable recording medium may include any usable medium that may be accessed by computers, volatile and non-volatile medium, and detachable and non-detachable medium. The computer-readable recording medium may include a computer storage medium. The computer storage medium includes all volatile and non-volatile media, and detachable and non-detachable media which are technically implemented to store information including computer-readable instructions, data structures, program modules or other data.

Various embodiments of the disclosure may be implemented in a software (S/W) program including instructions stored in a computer-readable storage medium.

A computer is a device capable of calling the stored instructions from the storage medium and operating according to various embodiments of the disclosure in accordance with the called instructions, and may include an electronic device according to various embodiments.

The computer-readable storage medium may be provided in the form of a non-transitory storage medium. Here, the ‘non-transitory’ storage medium is tangible and may not refer to a transitory electrical signal, but does not distinguish that data is stored semi-permanently or temporarily on the storage medium.

Furthermore, a control method according to various embodiments of the disclosure may be provided in a computer program product. The computer program product may be traded between a seller and a purchaser as a commodity.

The computer program product may include an S/W program and a computer-readable storage medium having stored thereon the S/W program. For example, the computer program product may include a product (e.g. a downloadable application) in an S/W program distributed electronically through a manufacturer of an electronic device or an electronic market (e.g., Google Play Store and/or App Store). For electronic distribution, at least a part of the S/W program may be stored on the storage medium or may be generated temporarily. In this case, the storage medium may be a storage medium of a server of the manufacturer, a server of the electronic market, or a relay server for temporarily storing the S/W program.

The computer program product may include a storage medium of a server or a storage medium of an electronic device, in a system including the server and the electronic device. When there is a third device (e.g., a smartphone) that communicates with the server or the electronic device, the computer program product may include a storage medium of the third device. Alternatively, the computer program product may include an S/W program that is transmitted from the server to the electronic device or the third device or from the third device to the electronic device.

In this case, one of the server, the electronic device, and the third device may perform the method according to various embodiments of the disclosure by executing the computer program product. Alternatively, at least two of the server, the electronic device, and the third device may divide and perform the method according to various embodiments of the disclosure by executing the computer program product.

For example, the server (e.g., a cloud server, an AI server, or the like) may execute the computer program product stored in the server, thereby controlling the electronic device to perform the method according to various embodiments of the disclosure, the electronic device communicating with the server.

As another example, the third device may execute the computer program product, thereby controlling the electronic device to perform the method according to various embodiments of the disclosure, the electronic device communicating with the third device. When the third device executes the computer program product, the third device may download the computer program product from the server, and may execute the downloaded computer program product. The third device may perform the method according to various embodiments of the disclosure by executing a pre-loaded computer program product.

Throughout the disclosure, the term “unit” may indicate a hardware component such as a processor or a circuit, and/or may indicate a software component that is executed by a hardware configuration such as a processor.

While the disclosure has been particularly shown and described with reference to the accompanying drawings, in which various example embodiments of the disclosure are illustrated and described, it will be apparent to one of ordinary skill in the art that the disclosure may be easily embodied in many different forms without changing the technical concept or essential features of the disclosure. Thus, it should be understood that the various example embodiments described herein should be considered in a descriptive sense only and not for purposes of limitation. For example, configuring elements that are singular forms may be executed in a distributed fashion, and also, configuring elements that are distributed may be combined and then executed.

What is claimed is:

1. An electronic device comprising:
a memory comprising one or more instructions; and
at least one processor comprising processing circuitry,
wherein at least one processor, individually or collectively, is configured to execute the one or more instructions and to cause the electronic device to:
based on a playback request for a channel providing live streaming content being received, obtain, from a server, a plurality of segments based on an index file corresponding to the channel,
determine whether there is most-recent segment information stored in correspondence with the channel, the most-recent segment information comprising information about a segment that was most recently played back in a previous playback on the channel,
based on the most-recent segment information existing, identify a playback start segment using the most-recent segment information and information about a segment specified based on the index file, and
play back the identified playback start segment.

2. The electronic device of claim 1, wherein at least one processor, individually or collectively, is configured to cause the electronic device to:
based on the most-recent segment information existing,
based on a segment number of the segment specified based on the index file being equal to or less than a segment number of the most-recent segment, identify, as the playback start segment, a segment corresponding to a next segment number subsequent to the segment number of the most-recent segment, and
based on the segment number of the segment specified based on the index file being greater than the segment number of the most-recent segment, identify, as the playback start segment, the segment specified based on the index file.

3. The electronic device of claim 1, wherein at least one processor, individually or collectively, is configured to cause the electronic device to:
based the most-recent segment information not existing, identify, as the playback start segment, the segment designated based on the index file.

4. The electronic device of claim 1, wherein the segment designated based on the index file indicates a segment corresponding to a number located at a specified position from among numbers of the plurality of segments included in the index file.

5. The electronic device of claim 1, wherein at least one processor, individually or collectively, is configured to cause the electronic device to:
based on a playback end request for the channel being received, store a segment number of a segment most recently played back on the channel as the most-recent segment information corresponding to the channel.

6. The electronic device of claim 1, wherein
the index file comprises information about each of the plurality of segments, and
the information about each segment comprises a uniform resource locator (URL) for obtaining each segment.

7. The electronic device of claim 1, wherein at least one processor, individually or collectively, is configured to cause the electronic device to:
transmit a request to the server using a URL for each segment of the plurality of segments included in the index file, and receive, from the server, the plurality of segments corresponding to the index file.

8. The electronic device of claim 1, wherein at least one processor, individually or collectively, is configured to cause the electronic device to:
periodically request the server for the index file and receive an updated index file from the server, and
receive, from the server, an updated plurality of segments based on the updated index file.

9. A method of operating an electronic device, the method comprising:
based on a playback request for a channel providing live streaming content being received, obtaining, from a server, a plurality of segments based on an index file corresponding to the channel;
determining whether there is most-recent segment information stored in correspondence with the channel, the most-recent segment information comprising information about a segment that was most recently played back in a previous playback on the channel;
based on the most-recent segment information existing, identifying a playback start segment using the most-recent segment information and information about a segment designated based on the index file; and
playing back the identified playback start segment.

10. The method of claim 9, further comprising:
based on the most-recent segment information existing,
based on a segment number of the segment designated based on the index file being equal to or less than a segment number of the most-recent segment, identifying, as the playback start segment, a segment corresponding to a next segment number subsequent to the segment number of the most-recent segment; and
based on the segment number of the segment designated based on the index file being greater than the number of the most-recent segment, identifying, as the playback start segment, the segment designated based on the index file.

11. The method of claim 9, further comprising, based on the most-recent segment information not existing, identifying, as the playback start segment, the segment designated based on the index file.

12. The method of claim 9, wherein the segment designated based on the index file indicates a segment corresponding to a segment number located at a specified position from among segment numbers of the plurality of segments included in the index file.

13. The method of claim 9, further comprising, based on a playback end request for the channel being received, storing a segment number of a segment most recently played back on the channel as the most-recent segment information corresponding to the channel.

14. The method of claim 9, wherein
the index file comprises information about each of the plurality of segments, and
the information about each segment comprises a uniform resource locator (URL) for obtaining each segment.

15. The method of claim 9, further comprising transmitting a request to the server using a URL for each segment of the plurality of segments included in the index file, and receiving, from the server, the plurality of segments corresponding to the index file.

16. The method of claim 9, further comprising:
periodically requesting the server for the index file and receiving an updated index file from the server; and
receiving, from the server, an updated plurality of segments based on the updated index file.

17. A non-transitory computer-readable medium storing one or more instructions executable by at least one processor, comprising processing circuitry, of an electronic device, wherein the one or more instructions, when executed by at least one processor, individually and/or collectively, cause the electronic device to:
based on a playback request for a channel providing live streaming content being received, obtain, from a server, a plurality of segments based on an index file corresponding to the channel,
determine whether there is most-recent segment information stored in correspondence with the channel, the most-recent segment information comprising information about a segment that was most recently played back in a previous playback on the channel,
based on the most-recent segment information existing, identify a playback start segment using the most-recent segment information and information about a segment designated based on the index file, and
play back the identified playback start segment.
